(19) United States
(12) Patent Application Publication
(10) Pub. No.: US 2004/0225489 A1
(43) Pub. Date: Nov. 11, 2004

(54) Integrated self-testing of a reconfigurable interconnect

(75) Inventors: David Fenech Saint Genieys, Malakoff (FR); Gilles Laurent, Boulogne (FR)

Correspondence Address: BANNER & WITCOFF, 1001 G STREET N W, SUITE 1100, WASHINGTON, DC, 20001, US

(73) Assignee: Mentor Graphics, Wilsonville, OR (US)

(21) Appl. No.: 10/428,917

(22) Filed: May 5, 2003

(51) Int. Cl. G06F 9/455

(52) U.S. Cl. 703/25

(57) ABSTRACT

Methods and systems for increasing the speed with which configuration data can be loaded and tested on a reconfigurable interconnect device are disclosed. A reconfigurable interconnect integrated circuit (IC), or a reconfigurable portion of an integrated circuit, is coupled to a digital storage circuit such as a shift register. A seed configuration pattern is loaded once into the digital storage circuit, which is loaded onto a first set of switches in the integrated circuit. The shift register shifts the configuration patterns by a predetermined amount, and then loads the shifted configuration pattern onto a second set of switches in the integrated circuit. Using the digital storage circuit coupled to the reconfigurable interconnect, each integrated circuit only needs to load a configuration pattern once, instead of reloading a new configuration pattern for each set of switches in the integrated circuit.

### FIELD OF THE INVENTION

The present invention relates to the field of integrated circuits (IC). More specifically, the present invention relates to the testing of a reconfigurable interconnect portion of an IC used in an emulation system.

### BACKGROUND OF THE INVENTION

The first generation of emulation systems were formed using general purpose FPGAs without integrating debugging facilities. To emulate a circuit design on one of such emulation systems, the circuit design would be “realized” by compiling a formal description of the circuit design, partitioning the circuit design into subsets, mapping various subsets to the logic elements (LEs) of the FPGAs of various logic boards of the emulations system, and then configuring various interconnects to interconnect the LEs. The partitioning and mapping operations would be typically performed on workstations that are part of or complementary to the emulation systems, while the configuration information would be correspondingly downloaded onto the logic boards hosting the FPGAs, and then onto the FPGAs.

During emulation, test stimuli were generated, and then transferred to various logic boards for input into the emulation ICs for application to the various netlists of the IC design being emulated. State data of various circuit elements as well as signal states of interest of the IC design being emulated, would be correspondingly read out of the applicable FPGAs, and then transferred off the logic boards, for analysis on the workstation.

Due to the nature of the emulation system for testing, an important aspect of emulation systems is the capability of the emulation system to test itself to ensure that the emulation system is functioning properly (i.e., self-test). That is, if the logic used to emulate a design is itself faulty, a user of the emulation system may be led astray by such faulty logic. The user may be falsely led to believe that the design is working properly. Alternatively, the user may be led to believe that a failure of a design to perform as expected in the emulator is due to a design failure of the design under verification rather than the emulation system, which may be the cause of the failure. That is, when there is faulty emulation circuitry, the design may be proper, but the faulty emulation logic may cause the undesired results from the emulation. Accordingly, when an emulation system is powered on, the emulation system may perform a series of tests on the components of the emulation system such as reconfigurable interconnect portions of ICs used in the emulation system, to ensure that at least the emulation system is working properly.

Later generations of emulation systems have employed emulation integrated circuits with increased density of reconfigurable logic and interconnects, which in turn, have increased the amount of time required to perform these self-tests. Commonly, self-testing involves processes similar to operation during emulation, as described above. In order to self-test components, such as reconfigurable interconnect ICs, or a reconfigurable interconnect portion of an IC, a series of self-test stimuli are generated, and then transferred to various logic boards for input into the ICs, as described above. Each of the series of self-test stimuli tested a particular component or a particular sub-component of the emulation ICs. Expected results from the self-test stimuli were compared with actual results from the self-test stimuli. That is, if a single switch in a switching matrix was not functioning properly, the actual result from the self-test stimuli would vary from the expected result from the self-test stimuli.

Self-testing and emulation both required extensive configuration and reconfiguration of emulation components, including the reconfigurable interconnect ICs. Accordingly, the time required to perform a self-test could often have been as much time as was required to perform an emulation. Thus, an improved approach to configuring reconfigurable switching ICs to facilitate a series of self-tests is desired.

### SUMMARY

Aspects of the present invention overcome one or more of the above limitations and drawbacks by providing, on a reconfigurable interconnect, a memory or other storage device that shifts test patterns and loads them into the interconnect array for self-testing. According to an aspect of the invention, an integrated circuit (IC) may include a reconfigurable interconnect portion and a shift register coupled to the reconfigurable interconnect portion, where the shift register stores a shiftable configuration pattern for use by the reconfigurable interconnect portion.

According to another aspect of the invention, an integrated circuit may include a reconfigurable interconnect portion and a logic portion, such as a digital storage circuit or shift register, coupled to the reconfigurable interconnect portion. The logic portion can be configured to provide a first or seed bit pattern to the reconfigurable interconnect portion thereby facilitating a first configuration of the reconfigurable interconnect portion, and configured to shift the first bit pattern to generate and provide to the reconfigurable interconnect portion a second bit pattern thereby facilitating a second configuration of the reconfigurable interconnect portion. By receiving only a single configuration pattern, and shifting the configuration pattern as needed, self-testing time may be reduced.

According to another aspect of the invention, there is a method for testing a reconfigurable interconnect in an emulation system. The method may include steps of providing a seed bit pattern to a reconfigurable interconnect, thereby configuring a first set of switches of the reconfigurable interconnect, determining whether the reconfigurable interconnect is fully configured with respect to a predetermined configuration, upon determining that the reconfigurable interconnect portion is not fully configured in the predetermined configuration, shifting the seed bit pattern to result in a new bit pattern, and providing the new bit pattern to the reconfigurable interconnect thereby configuring a second set of switches of the reconfigurable interconnect.

These and other features of the invention will be apparent upon consideration of the following detailed description of illustrative embodiments.

### BRIEF DESCRIPTION OF THE DRAWINGS

The present invention will be described by way of illustrative embodiments, but not limitations, illustrated in the accompanying drawings in which like references denote similar elements, and in which:

FIG. 1 illustrates an arrangement of logic boards in accordance with at least one aspect of an illustrative embodiment of the present invention;

FIG. 2 illustrates an overview of an emulation system in accordance with at least one aspect of an illustrative embodiment of the present invention;

FIGS. 3A-3B illustrate a novel arrangement for configuring emulation components to facilitate self-testing of the components, in accordance with at least one aspect of an illustrative embodiment of the present invention;

FIG. 4 illustrates examples of bit patterns and corresponding states of individual switches that may be utilized to self-test a reconfigurable interconnect, in accordance with at least one aspect of an illustrative embodiment of the present invention;

FIG. 5 illustrates a novel arrangement for configuring emulation components to facilitate self-testing of the components, in accordance with at least one aspect of an illustrative embodiment of the present invention;

FIG. 6 illustrates a novel arrangement for configuring reconfigurable interconnects to facilitate self-testing, in accordance with at least one aspect of an illustrative embodiment of the present invention; and

FIG. 7 illustrates an operational flow for improved novel approach to self-testing reconfigurable interconnects, wherein a reconfigurable interconnect may be configured by utilizing shifting devices, in accordance with at least one aspect of an illustrative embodiment of the present invention.

### DETAILED DESCRIPTION

In the following description of various illustrative embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

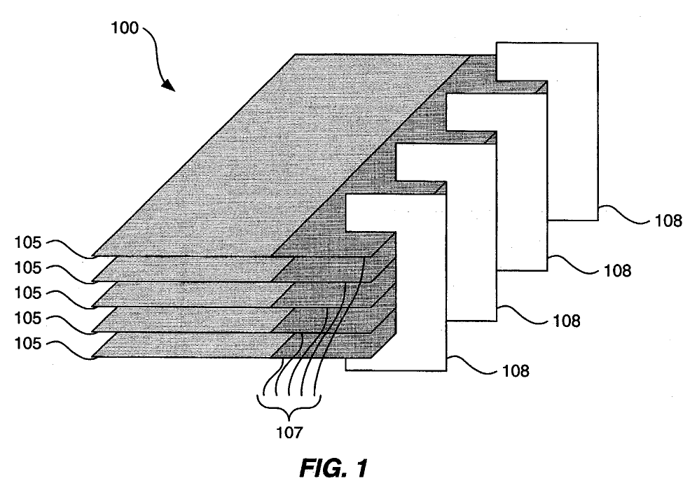

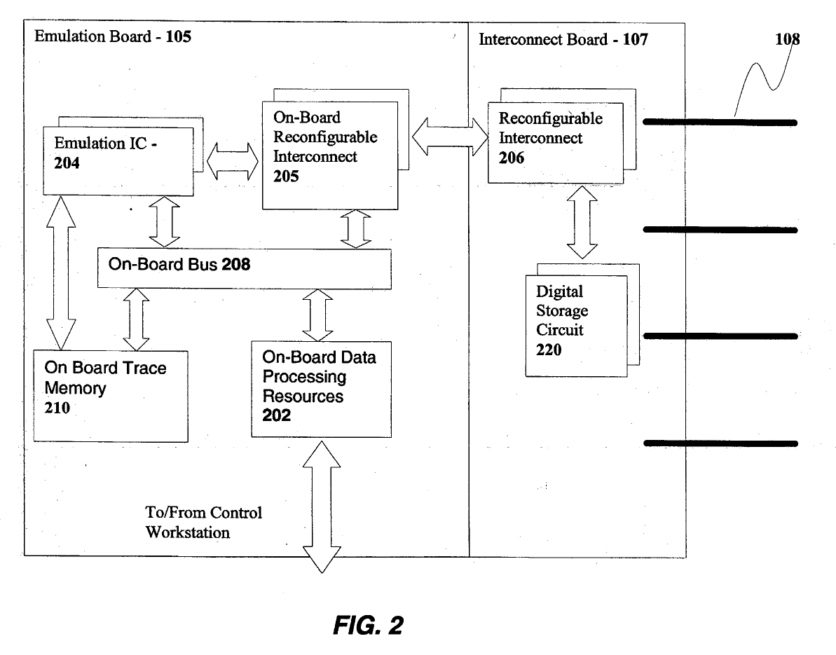

Illustrated in FIG. 1 is an example of an arrangement for an emulation system 100. The emulation system 100 may include one or more emulation boards 105 coupled to each other via one or more interconnect boards 107 and 108. Interconnect boards 107 and 108 may include various integrated circuits, such as, but not limited to, reconfigurable interconnects 206 (shown in FIG. 2). The emulation boards 105 may include various resources, such as, but not limited to, on-board emulation ICs 204 (shown in FIG. 2).

Emulation systems may perform self-testing prior to emulating a circuit design. In order to provide a sense of scale of testing involved, in one illustrative embodiment of the emulation system 100, the interconnect boards 107 and 108 may each have eight reconfigurable interconnects 206, each capable of mapping 132 inputs to any of 132 outputs. Self-testing these reconfigurable interconnects 206 may involve testing whether every input can be routed to every output, or at least that a plurality of the inputs can each be routed to a plurality of the outputs. Accordingly, for n input to n output reconfigurable interconnects 206, up to n! configurations may be tested to ensure proper mapping of inputs to outputs.

Referring to FIG. 2, for the illustrated embodiment, emulation board 105 includes on-board data processing resources 202, on-board emulation ICs 204, on-board reconfigurable interconnects 205, on-board bus 208, and on-board trace memory 210 coupled to each other as shown (e.g., through on-board bus 208). Additionally, on-board emulation ICs 204 may also be directly coupled to on-board trace memory 210. Emulation board 105 may further include a number of I/O pins (not shown). A first subset of pins may be employed to couple selected ones of the outputs of on-board reconfigurable interconnects 205 to reconfigurable interconnects 206 of interconnect board 107, which in turn, may be coupled to interconnect boards 108, thereby coupling the emulation resources of a number of logic boards. A second subset of pins may be employed to couple data processing resources 202 to certain control resources, such as a control workstation.

Interconnect boards 107 may include one or more reconfigurable interconnects 206 coupled to a number of digital storage circuits 220. The reconfigurable interconnects 206 may be coupled to reconfigurable interconnects (not shown) included on the interconnect boards 108. The reconfigurable interconnects included on the interconnect boards 108 may also be coupled to digital storage circuits of the type shown on interconnect boards 107. For ease of understanding, references will be made to a single reconfigurable interconnect 206 and a single digital storage circuit 220. However, as previously described, it should be appreciated by those skilled in the art that any number of reconfigurable interconnects 206 and digital storage circuits may be used.

Digital storage circuit 220 may be a shift register, where information, such as 1's and 0's are stored and shifted. Such shifting may occur in response to a control signal, or may occur automatically according to a predetermined scheme. In one embodiment, the reconfigurable interconnect 206 may be a switching matrix for programmatically connecting n inputs to m outputs, such as, but not limited to, a crossbar switch. Accordingly, an emulation system may be formed using multiple ones of interconnect boards 107 and 108, wherein digital storage circuits 220 may be employed to configure and/or test reconfigurable interconnects 206. As a result, the operation efficiency associated with configuring reconfigurable interconnects for self-test of an emulation system may be improved.

In various embodiments, each emulation IC 204 may include integrated debugging facilities, such as those included with enhanced FPGAs such as those described in U.S. Pat. No. 5,777,489, and U.S. Pat. No. 6,265,894, each of which is herein incorporated by reference as to their entireties. Additionally, in various embodiments, each reconfigurable interconnect 206 may comprise a crossbar device. On-board bus 208 and on-board trace memory 210 may perform their conventional functions of facilitating on-board communication/data transfers, and collection of signal states of the various emulation signals of the assigned partition of the IC design being emulated. On-board data processing resources 202 distributively and correspondingly perform emulation functions responsive to testing and/or monitor requests from the control resources of the emulation system. On-board reconfigurable interconnects 205 may facilitate coupling of the emulation resources of the various emulation ICs 204 of the different emulation boards 105 employed to form an emulation system 100.

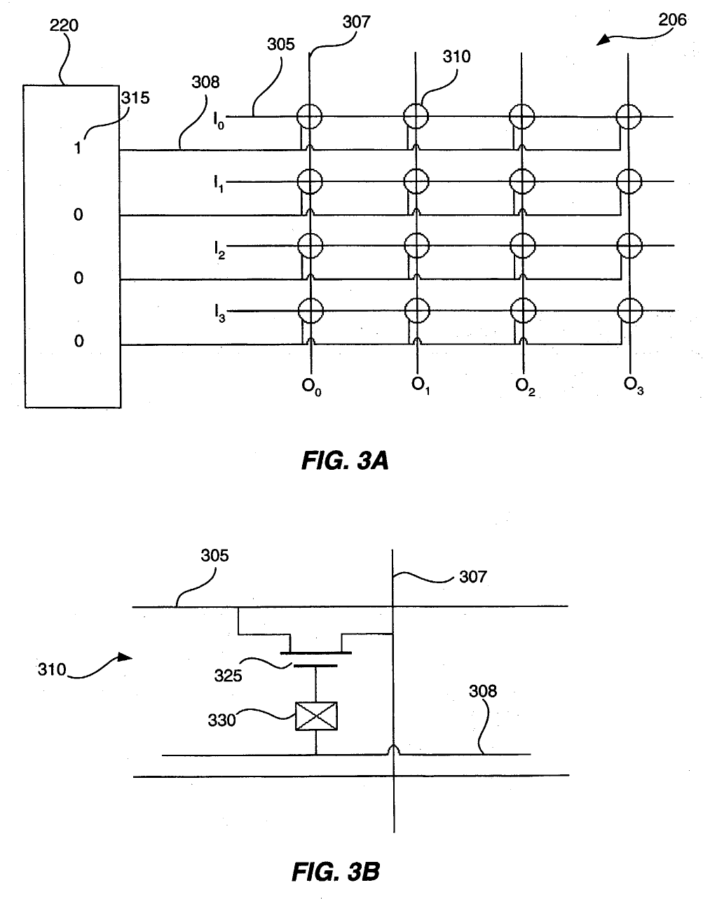

Referring to FIG. 3A, the reconfigurable interconnect 206 is illustrated in further detail. The reconfigurable interconnect 206 is shown as a switching matrix having a number of horizontal paths 305, a number of vertical paths 307, and a number of switches 310 for connecting any one of the horizontal paths 305 with any one of the vertical paths 307. The horizontal paths 305 may be operable as input lines I0-I3, and vertical paths 307 may be operable as output lines O0-O3. The input lines I0-I3 are connectable to output lines O0-O3 through switches (I0, O0)-(I3, O3). For ease of describing the present invention, each switch is described herein in terms of its positional coordinates utilizing the input lines I0-I3 and output lines O0-O3. For example, the switch in the upper left of FIG. 3A will be referred to as switch (I0, O0), and the switch in the lower right of FIG. 3A will be referred to as switch (I3, O3).

As illustrated in FIG. 3A, all of the switches (I0, O0)-(I3, O3 are coupled to the digital storage circuit 220. As stated above, the digital storage circuit 220 may be a shift register. The digital storage circuit 220 is shown having a bit pattern 315, in this case {1000}. Furthermore, for the illustrated embodiment, the digital storage circuit 220 may be a four-bit shift register coupled to the four-input-by-four-output reconfigurable interconnect 206. However, the shift register may be of any size, such as a shift register of two bits or more, as further described below.

Referring now to FIG. 3B, a single illustrative switch 310 is shown in detail. The switch 310 may comprise an NMOS pass transistor 325 with its source connected to one input line 305 and its drain connected to one output line 307. The gate of the transistor 325 may be coupled to and controlled by a memory element 330. Connection between the one input line 305 and the one output line 307 is effectuated by applying a control signal at the gate of the transistor 325. Accordingly, memory 330 is coupled to the digital storage circuit 220 via control line 308, which provides the control signal and results in the memory element 330 storing a 1 or a 0. When the memory element stores a 1, an “on” state is represented (i.e., the transistor 325 connects the horizontal input path 305 with the vertical output path 307). When the memory element 330 stores a 0, an “off” state is represented (i.e., the transistor 325 does not connect the horizontal input path 305 with the vertical output path 307). In order for the memory element 330 to receive the switch control signal, the memory element 330 may receive a reception control signal (not shown), such as but not limited to, a clock signal. The reception control signal may be different (e.g., have different timing characteristics) for each column of switches facilitating the coupling as shown in FIG. 3A.

In operation, and referring back to FIG. 3A, the bit pattern 315 in the digital storage circuit 220 may initially be received by the first column of switches in the reconfigurable interconnect 206 in response to the reception control signal. In particular, the bit pattern 315 is received by the memory elements 330, thereby causing switch (I0, O0) to be in the on state, while causing switches (I1, O0), (I2, O0), and (I3, O0) to be in the off state. Subsequently, in response to a shift control signal, such as, but not limited to, a clock signal, the bit pattern 315 in the digital storage circuit 220 is shifted by a predetermined amount up or down. The shift amount and direction of shift may be based at least upon the type of the digital storage circuit 220 and/or the shift control signal. Once the original bit pattern 315 is shifted, a new bit pattern is present in the digital storage circuit 220 for the next column of switches (O0, O1), (I1, O1), (I2, O1), and (I3, O1). The next column of switches (I0, O1), (I1, O1), (I2, O1), and (I3, O1) may receive a different reception control signal than the first column of switches (I0, O0), (I1, O0), (I2, O0), and (I3, O0). This process is repeated a predetermined number of times in order to configure at least a portion of the reconfigurable interconnect 206 for self-testing.

In one embodiment, the digital storage circuit 220 may perform the shifting automatically (i.e., the digital storage circuit 220 may be placed in an auto-shift mode), for example, by using a dedicated software command or by any other automated control mechanism. In an alternate embodiment, the digital storage circuit 220 may shift a bit pattern in response to a received shift control signal. As a result, configuring reconfigurable interconnects may be simplified, which in turn, may increase the operating efficiency associated with configuring reconfigurable interconnects for self-testing.

In FIGS. 3A-3B, a 4-input-by-4-output reconfigurable interconnect is shown; however, it should be appreciated by one skilled in the art that the number of inputs and outputs in the reconfigurable interconnect 206 may be any number (i.e., n inputs by m outputs, where n and m may be equal or different).

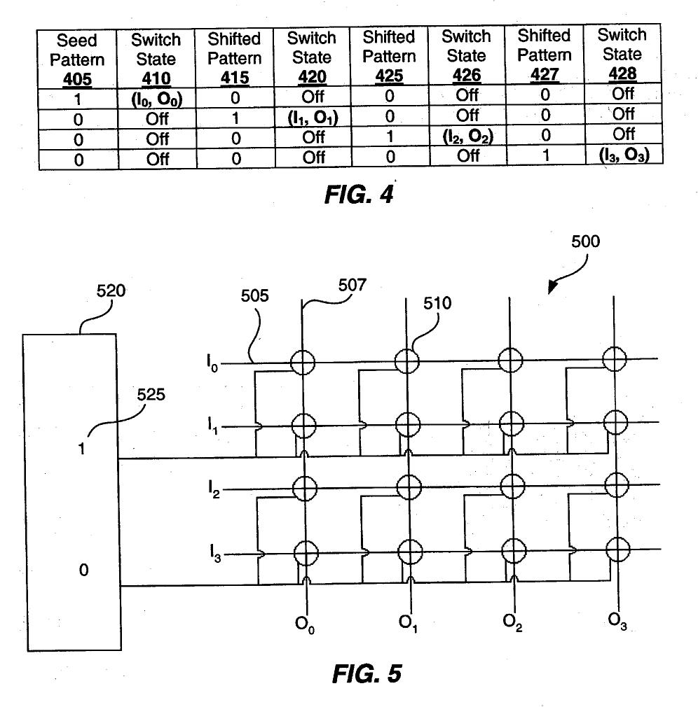

FIG. 4 illustrates examples of bit patterns 315 and corresponding states of individual switches 310 that may be utilized to self-test a reconfigurable interconnect 206, in accordance with an illustrative embodiment of the present invention. A first column 405 illustrates an example of a seed bit pattern that may be initially stored in a digital storage circuit. The seed bit pattern of column 405 may be a predetermined bit pattern to configure the reconfigurable interconnect 206 into a desired configuration for self-testing. A first column of switches receives the seed pattern for the desired configuration. A second column 410 illustrates the state of the first column of switches corresponding to the received seed bit pattern of column 405. In the embodiment illustrated, in column 410, the switch at location (I0, O0) is in the on state, while the other switches (I1-I3, O0) in the first column of switches are in the off state.

Subsequently, the seed bit pattern in the digital storage circuit is shifted a predetermined amount up or down. The predetermined amount up or down and/or the direction of shift may be based at least upon the type of digital storage circuit 220, it's the shift control signal, and/or the type of reconfigurable interconnects 206.

Continuing to refer to FIG. 4, a third column 415 illustrates the resulting shifted bit pattern. That is, in the illustrative embodiment of FIG. 4, the seed bit pattern of column 405 is shifted by one bit in the down direction resulting in the shifted bit pattern of column 415. The shifted bit pattern of column 415 is received by a second column of switches such that the reconfigurable interconnect 206 is provided another configuration for self-testing. A fourth column 420 of table 400 illustrates the state of the switches corresponding to the shifted bit pattern of column 415. In the embodiment illustrated in FIG. 4, in column 420, the switch at location (I1, O1) is in the on state, while the other switches (I0, O1), (I2-I3, O1), in the second column of switches are in the off state.

This method of testing and shifting may be repeated until the reconfigurable interconnect is fully configured. Fully configured means that all of the switches of the reconfigurable interconnect are configured by the digital storage circuit 220. That is, a fifth, sixth, seventh, and eighth columns 425-428 of FIG. 4 illustrate repeated shifting of bit patterns and their corresponding switch states, respectively. The fifth, sixth, seventh, and eighth columns 425-428 of FIG. 4 illustrate shifting of a bit pattern by one bit in the down direction.

Once the reconfigurable interconnect 206 is configured, a self-test may be run to determine whether the reconfigurable interconnect is functioning properly. A predetermined test pattern may be received by the reconfigurable interconnect 206 and the output may be compared to an expected output based at least upon the predetermined test pattern and the configuration of the switches within the reconfigurable interconnect 206. If one or more switches is/are not functioning properly, the actual output will most likely not match the expected output, thereby providing a means for detecting faulty logic within the reconfigurable interconnect 206.

Alternatively, a self-test may be performed as the reconfigurable interconnect 206 is being configured. For example, a self-test may be performed after the first column of switches is configured facilitating targeted testing of individual switches, but prior to the second column of switches being configured.

In one embodiment, in order to facilitate testing of configurations utilizing switches in various positions within a reconfigurable interconnect, the bit pattern 315 may be shifted a predetermined amount before being received by the reconfigurable interconnect 206. For example, referring back to FIGS. 3A-3B, the memory element 330 may be controlled by a reception control signal that is different than the shift control signal utilized by the digital storage circuit 220 to shift the bit pattern, such as, but not limited to, a divide-by-two clock signal. Accordingly, in FIG. 4, the third column 415 of table 400 would result in a shifted bit pattern of {0010}, read top to bottom. Correspondingly, the fourth column 420 of table 400 would result in switch (I2, O1) being in an on state and not switch (I1, O1) as previously described.

In one embodiment, the predetermined amount of the shifting of the bit pattern 315 may be based at least upon the number of inputs and outputs that the reconfigurable interconnect 206 may have. For example, referring back to FIG. 3A, if reconfigurable interconnect 206 has an odd number of inputs and outputs (i.e., n being an odd number and m being an odd number), the bit pattern 315 may be shifted an odd number times before being received by the reconfigurable interconnect 206 to configure the desired switch(es) 310.

In one embodiment, the shifting of the bit patterns may be performed automatically. For example, the on-board data processing resources 202 (shown in FIG. 2) may receive instructions to provide the shift control signal, such as, but not limited to, a clock signal, to the digital storage circuit 220 at regular or irregular intervals. In an alternate embodiment, the control workstation (not shown) may be utilized to provide a control signal to the digital storage circuit 220 as desired or commanded by a user and/or an application running on the control workstation (not shown).

FIG. 5 illustrates an arrangement for configuring emulation components to facilitate self-testing of the components, in accordance with an alternate illustrative embodiment of the present invention. In the embodiment of FIG. 5, a reconfigurable interconnect 500 is shown as a switching matrix having a number of horizontal paths 505, a number of vertical paths 507, and a number of switches 510 for connecting any one of the horizontal paths 505 with any one of the horizontal paths 507. Similar to the reconfigurable interconnect 206 shown in FIGS. 3A-3B, horizontal paths 507 may be operable as input lines I0-I3, and the vertical paths 305 may be operable as output lines O0-O3. The input lines I0-I3 are connectable to output lines O0-O3 through switches (I0, O0)-(I3, O3. However, unlike the previously described reconfigurable interconnect 206 of FIGS. 3A-3B, the reconfigurable interconnect 500 shown FIG. 5 has pairs of switches 510 each controlled by a single memory element (not shown). Accordingly, the embodiment of the present invention shown in FIG. 5 has a digital storage circuit 520 that has a reduced number of bits 525, allowing the use of a smaller digital storage circuit. As a result, based at least upon the type of reconfigurable interconnects, a relatively small digital storage circuit may be utilized to configure the reconfigurable interconnects for self-testing.

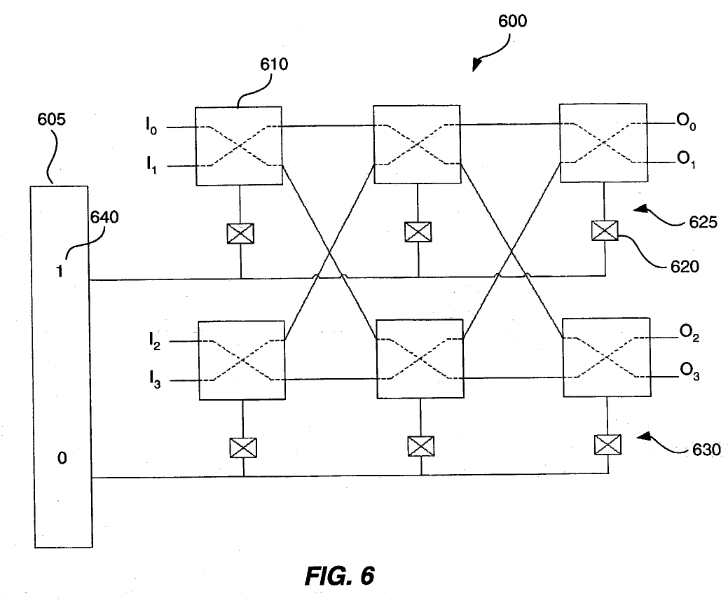

FIG. 6 illustrates another embodiment that may be used in conjunction with aspects of the present invention. In the embodiment of FIG. 6, a digital storage circuit 605 is coupled to a reconfigurable interconnect in the form of a multi-stage switching network 600 of six two-signal switching circuits 610. In this embodiment, the switching network 600 has three stages. The three-stage switching network 600 may be a three-stage switching network, such as, but not limited to, a three-stage Clos switching network. As shown, the three-stage network 600 has four inputs I0-I3 that may be reconfigurably coupled to four outputs O0-O3. Additionally, the six two-signal switching circuits 610 are shown as two rows of three.

The six two-signal switching circuits 610 are each coupled to memory elements 620 to facilitate control of each of the six two-signal switching circuits 610. In particular, a first row of memory elements 625 is coupled to the digital storage circuit 605, and a second row of memory elements 630 is also coupled to the digital storage circuit 605.

As illustrated in the alternate embodiment of present invention of FIG. 6, the digital storage circuit 605 stores a bit pattern 640 to be received by at least some of the memory elements 620. Because of the architecture of the three-stage switching network 600, the illustrative embodiment of the present invention shown in FIG. 6 is able to use a digital storage circuit 605 that stores a reduced number of bits 640 facilitating use of a smaller digital storage circuit.

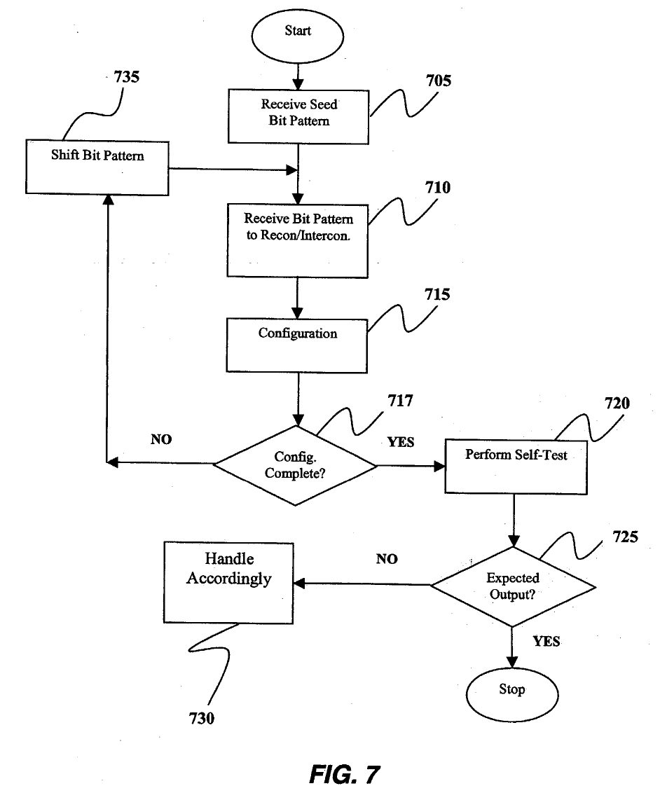

FIG. 7 illustrates an operational flow for an improved approach to self-testing reconfigurable interconnects, wherein a reconfigurable interconnect may be configured by utilizing shifting devices, in accordance with an illustrative embodiment of the present invention. At operational block 705, a digital storage circuit, such as, but not limited to, a shift register, that is coupled to a reconfigurable interconnect receives an initial seed bit pattern. At operational block 710, the present bit pattern (in the first iteration, this will comprise the seed bit pattern) is received by the reconfigurable interconnect, in particular, the memory elements of the reconfigurable interconnect. In response to the seed bit pattern, switches, that are coupled to the memory elements, are placed in various states resulting in configuration of the reconfigurable interconnect, at operational block 715. At operational block 717, it is shown whether configuration of the reconfigurable interconnect is complete, i.e., whether the reconfigurable interconnect has received the desired configuration to enable self-testing.

If the reconfigurable interconnect has the desired configuration, a self-test is run to determine that the reconfigurable interconnect is functioning properly, at operational block 720. If it is determined that the configuration is not complete, the seed bit pattern is shifted a predetermined number generating a new bit pattern, at operational block 735.

At operational block 725, it is determined whether the output is as expected based at least upon the predetermined test pattern and the expected configuration of the switches within the reconfigurable interconnect. If the output is as expected (i.e., the switches in the reconfigurable interconnect are functioning properly), self-testing may be considered complete. However, if it is determined that the output is not as expected, the self-test is stopped and data from the self-test may be handled and analyzed accordingly (operational block 730).

Thus, a novel approach to self-testing reconfigurable interconnects may be implemented, wherein a digital storage circuit, may be coupled to a reconfigurable interconnect to facilitate self-testing of the reconfigurable interconnect. A test configuration seed pattern may be loaded once, and subsequently shifted until the entire switching matrix has been configured for a self-test, instead of requiring multiple configuration patterns to be loaded for each switching matrix. In addition, a single test configuration pattern for each switching matrix can be loaded into multiple reconfigurable interconnects, and then testing can commence simultaneously in each reconfigurable interconnect. Any loss in area on the IC resulting from the use of the digital storage circuit may be offset by the reduction in time required to the test the IC.

While the invention has been described with respect to a reconfigurable interconnect device, those of skill in the art will appreciate that the inventive principles can be used for any interconnect portion of any IC, and is not limited for use only with dedicated reconfigurable interconnect devices. Also, while the present invention has been described with regard to an emulation environment, it will be recognized that the present invention may be practiced in other environments that self-test reconfigurable interconnects. Further, all references to bits set to zero or one are illustrative and may be reversed, and references to rows and columns may likewise be reversed.

While the methods and systems of the present invention have been described in terms of the above illustrated embodiments, those skilled in the art will recognize that the various aspects of the present invention can be practiced with modification and alteration within the spirit and scope of the appended claims. The description is thus to be regarded as illustrative instead of restrictive of the present invention. For example, each of the elements of the aforementioned embodiments may be utilized alone or in combination with elements of the other embodiments. There are any number of alternative combinations for defining the invention, which incorporate one or more elements from the specification, including the description, claims, and drawings, in various combinations or sub-combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It is intended that the written description of the invention contained herein covers all such modifications and alterations.

What is claimed is:

1. An integrated circuit (IC), comprising:
a reconfigurable interconnect portion; and
a logic portion coupled to the reconfigurable interconnect portion, the logic portion configured to provide a first bit pattern to the reconfigurable interconnect portion thereby facilitating a first configuration of the reconfigurable interconnect portion, and configured to shift the first bit pattern to generate and provide to the reconfigurable interconnect portion a second bit pattern thereby facilitating a second configuration of the reconfigurable interconnect portion.

2. The IC of claim 1, wherein the reconfigurable interconnect portion comprises a switching matrix.

3. The IC of claim 2, wherein switching matrix comprises a crossbar switch.

4. The IC of claim 1, wherein the reconfigurable interconnect portion comprises a multi-stage switching network.

5. The IC of claim 1, wherein the reconfigurable interconnect portion comprises one or more switches.

6. The IC of claim 5, wherein the one or more switches each comprise an NMOS pass transistor.

7. The IC of claim 1, wherein the reconfigurable interconnect portion comprises a plurality of memory elements, each memory element connected to at least one switch of the reconfigurable interconnect portion.

8. The IC of claim 1, wherein the logic portion comprises a shift register.

9. The IC of claim 1, wherein the logic portion comprises a shift register configured to receive a shift control signal and automatically shift the first bit pattern responsive to the shift control signal.

10. The IC of claim 1, wherein the logic portion comprises a shift register configured to shift the first bit pattern by a predetermined amount.

11. An emulation system comprising:
a plurality of emulation boards;
a plurality of interconnect boards interconnecting the plurality of emulation boards, wherein each of the plurality of interconnect boards has an integrated circuit having a reconfigurable interconnect portion and a logic portion coupled to the reconfigurable interconnect portion, wherein the logic portion is configured to provide a first bit pattern to the reconfigurable interconnect thereby facilitating a first configuration of the reconfigurable interconnect portion, and to shift the first bit pattern to generate a second bit pattern, thereby facilitating a second configuration of the reconfigurable interconnect portion.

12. The emulation system of claim 11, wherein the reconfigurable interconnect portion comprises a switching matrix.

13. The emulation system of claim 12, wherein the switching matrix comprises a crossbar.

14. The emulation system of claim 12, wherein the reconfigurable interconnect portion comprises a multi-stage switching network.

15. The emulation system of claim 14, wherein the three-stage switching network comprises a three-stage Clos switching network.

16. The emulation system of claim 12, wherein reconfigurable interconnect portion comprises at least one switch.

17. The emulation system of claim 16, wherein the at least one switch comprises an NMOS pass transistor.

18. The emulation system of claim 12, wherein the reconfigurable interconnect portion comprises at least one memory element.

19. The emulation system of claim 12, wherein the logic portion comprises a shift register.

20. The emulation system of claim 12, wherein the logic portion comprises a shift register configured to receive a control signal, and automatically shift the first bit pattern responsive to the control signal.

21. The emulation system of claim 12, wherein the digital storage circuit comprises a shift register configured to shift a bit pattern by a predetermined amount.

22. A method for testing a reconfigurable interconnect in an emulation system, the method comprising steps of:
providing a seed bit pattern to a reconfigurable interconnect, thereby configuring a first set of switches of the reconfigurable interconnect;
determining whether the reconfigurable interconnect is fully configured with respect to a predetermined configuration;
upon determining that the reconfigurable interconnect portion is not fully configured in the predetermined configuration, shifting the seed bit pattern to result in a new bit pattern; and
providing the new bit pattern to the reconfigurable interconnect thereby configuring a second set of switches of the reconfigurable interconnect.

23. The method of claim 22, further including a step of receiving the seed bit pattern at a shift register coupled to the reconfigurable interconnect.

24. The method of claim 22, wherein said reconfigurable interconnect comprises a switching matrix.

25. The method of claim 24, wherein said reconfigurable interconnect comprises a crossbar.

26. The method of claim 22, wherein said reconfigurable interconnect comprises a multi-stage switching network.

27. The method of claim 22, wherein said providing of the seed bit pattern to the reconfigurable interconnect comprises providing the seed bit pattern to a plurality of memory elements of the reconfigurable interconnect.

28. The method of claim 22, wherein said shifting of the seed bit pattern comprises receiving a shift control signal, and automatically shifting the seed bit pattern responsive to the shift control signal.

29. An integrated circuit (IC) comprising a reconfigurable interconnect portion and a shift register coupled to the reconfigurable interconnect portion, wherein said shift register stores a shiftable configuration pattern for use by the reconfigurable interconnect portion.

30. A method of emulating a design, comprising:
sending a netlist description to an emulation system;
receiving results from the emulation system, wherein the results are based on an emulation of the netlist by the emulation system, and wherein the emulation system performs a method of testing a reconfigurable interconnect portion of an integrated circuit (IC) in the emulation system prior to the emulation, the method comprising:
receiving a seed bit pattern at a digital storage circuit coupled to the reconfigurable interconnect portion;
providing the seed bit pattern from the digital storage circuit to a first set of one or more memory elements in the reconfigurable interconnect portion to configure a first set of switches of the reconfigurable interconnect portion;
determining if the reconfigurable interconnect portion is fully configured with respect to a predetermined configuration;
upon determining that the reconfigurable interconnect portion is not fully configured in the predetermined configuration, shifting the seed bit pattern in the digital storage circuit resulting in a new bit pattern; and
providing the new bit pattern from the digital storage circuit to a second set of one or more memory elements included in the reconfigurable interconnect portion to configure a second set of switches of the reconfigurable interconnect portion.

31. A method of emulating a design, comprising:
sending a netlist description to an emulation system that emulates a design based on the netlist, and wherein the emulation system performs a method of testing a reconfigurable interconnect portion of an integrated circuit (IC) in the emulation system prior to the emulation, the method comprising:
receiving a seed bit pattern at a digital storage circuit coupled to the reconfigurable interconnect portion;
providing the seed bit pattern from the digital storage circuit to a first set of one or more memory elements in the reconfigurable interconnect portion to configure a first set of switches of the reconfigurable interconnect portion;
determining if the reconfigurable interconnect portion is fully configured with respect to a predetermined configuration;
upon determining that the reconfigurable interconnect portion is not fully configured in the predetermined configuration, shifting the seed bit pattern in the digital storage circuit resulting in a new bit pattern; and
providing the new bit pattern from the digital storage circuit to a second set of one or more memory elements included in the reconfigurable interconnect portion to configure a second set of switches of the reconfigurable interconnect portion, and receiving results from the emulation system.
